(19) United States
(12) Patent Application Publication
(10) Pub. No.: US 2026/0249669 A1
(43) Pub. Date: Aug. 27, 2026

(54) RETROFITTABLE TONNEAU COVER LATCH SYSTEMS

(71) Applicant: FORD GLOBAL TECHNOLOGIES, LLC, Dearborn, MI (US)

(72) Inventors: Matthew B. Rutman, Westland, MI (US); Daniel Ritz, Windsor (CA); Ming Hong Choi, LaSalle (CA)

(21) Appl. No.: 19/065,081

(22) Filed: Feb. 27, 2025

(51) Int. Cl. B60J 7/19; B60J 7/14

(52) U.S. Cl. CPC B60J 7/198; B60J 7/141

(57) ABSTRACT

Tonneau cover latch systems are provided for motor vehicles. An exemplary latch system may be configured to latch and unlatch the tonneau cover relative to a cargo bed of a motor vehicle. The latch system may include a first striker mounted to a first side wall of the cargo bed, and a first latch assembly movable between a first position in which the first latch assembly is engaged to the first striker and a second position in which the first latch assembly is disengaged from the first striker. In an exemplary method, the latch system may be retrofitted to a tonneau cover as a drop-in replacement part of an existing latch system.

### TECHNICAL FIELD

This disclosure relates generally to motor vehicles, and more particularly to tonneau cover latch systems for motor vehicles.

### BACKGROUND

Motor vehicles typically include one or more cargo spaces for storing/hauling various types of cargo. For example, a pickup truck includes a cargo bed for storing/hauling cargo at the rear of the truck. A tonneau cover may be used to cover the cargo bed in order to protect the contents of the cargo bed from environmental elements and to enhance the overall aesthetics of the vehicle.

### SUMMARY

A motor vehicle according to an exemplary aspect of the present disclosure includes, among other things, a cargo bed, a tonneau cover, and a latch system configured to latch and unlatch the tonneau cover relative to the cargo bed. The latch system includes a first striker mounted to a first side wall of the cargo bed, and a first latch assembly movable between a first position in which the first latch assembly is engaged to the first striker and a second position in which the first latch assembly is disengaged from the first striker.

In a further non-limiting embodiment of the foregoing motor vehicle, the first striker extends along only a discrete portion of a length of the first side wall.

In a further non-limiting embodiment of either of the foregoing motor vehicles, the first striker includes a mounting portion that interfaces with a downfacing flange of the first side wall and a head portion that interfaces with a top surface of the first side wall.

In a further non-limiting embodiment of any of the foregoing motor vehicles, the head portion includes an inboard extending flange that provides a first latching interface of the latch system.

In a further non-limiting embodiment of any of the foregoing motor vehicles, a movable latch component of the first latch assembly includes a latching flange that provides a second latching interface of the latch system.

In a further non-limiting embodiment of any of the foregoing motor vehicles, a top surface of the latching flange engages an undersurface of the inboard extending flange to latch the tonneau cover to the cargo bed when the first latch assembly is in the first position.

In a further non-limiting embodiment of any of the foregoing motor vehicles, the first latch assembly includes a stationary carrier, a movable latch component, and a spring configured to bias the movable latch component into engagement with the first striker.

In a further non-limiting embodiment of any of the foregoing motor vehicles, the stationary carrier provides a first grip surface of the first latch assembly, and the movable latch component provides a second grip surface of the first latch assembly. The second grip surface is movable toward the first grip surface to disengage the movable latch component from the first striker.

In a further non-limiting embodiment of any of the foregoing motor vehicles, the second grip surface is accessible via a finger clearance opening of the first latch assembly.

In a further non-limiting embodiment of any of the foregoing motor vehicles, the first latch assembly includes an anti-theft structure established by a first blocking structure of the stationary carrier and a second blocking structure of the movable latch component.

In a further non-limiting embodiment of any of the foregoing motor vehicles, the latch system includes a second striker mounted to a second side wall of the cargo bed, and a second latch assembly movable between a first position in which the second latch assembly is engaged to the second striker and a second position in which the second latch assembly is disengaged from the second striker.

In a further non-limiting embodiment of any of the foregoing motor vehicles, the first latch assembly and the second latch assembly are simultaneously movable between the first positions and the second positions by a single user.

A latch system for a tonneau cover according to an exemplary aspect of the present disclosure includes, among other things, a first striker and a first latch assembly. The first latch assembly includes a stationary carrier, a movable latch component, and a spring configured to bias the movable latch component into engagement with the first striker.

In a further non-limiting embodiment of the foregoing latch system, the stationary carrier provides a first grip surface of the first latch assembly, and the movable latch component provides a second grip surface of the first latch assembly. The second grip surface is movable toward the first grip surface to disengage the movable latch component from the first striker.

In a further non-limiting embodiment of either of the foregoing latch systems, the second grip surface is accessible via a finger clearance opening of the first latch assembly.

In a further non-limiting embodiment of any of the foregoing latch systems, the stationary carrier is mountably received within a C-channel of a crossbar of the tonneau cover.

In a further non-limiting embodiment of any of the foregoing latch systems, the stationary carrier includes a catch that is configured to abut against an outboard end surface of the crossbar to delimit an insertion distance of the stationary carrier into the C-channel.

In a further non-limiting embodiment of any of the foregoing latch systems, the first latch assembly includes an anti-theft structure established by a first blocking structure of the stationary carrier and a second blocking structure of the movable latch component.

In a further non-limiting embodiment of any of the foregoing latch systems, the first blocking structure and the second blocking structure each include an inverted shark fin-like shape.

A method for retrofitting a latch system onto a tonneau cover according to another exemplary aspect of the present disclosure includes, among other things, disassembling a portion of the tonneau cover to expose a crossbar, removing an existing latch assembly from the crossbar, securing a latch assembly of the latch system to the crossbar, and reassembling the portion of the tonneau cover.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a motor vehicle equipped with a tonneau cover.

FIG. 2 is a rear view of the motor vehicle of FIG. 1 with the tonneau cover in a first position.

FIG. 3 is a rear view of the motor vehicle of FIG. 1 with the tonneau cover in a second position.

FIG. 4 illustrates an exemplary latch system for latching and unlatching a tonneau cover relative to a motor vehicle cargo bed.

FIG. 5 is a cross-sectional view through section 5-5 of FIG. 4.

FIG. 6 is a cross-sectional view through section 6-6 of FIG. 5.

FIG. 7 is a blown-up view of select portions of the latch system of FIG. 4.

FIG. 8 illustrates another exemplary latch system.

FIGS. 9, 10, 11, 12, 13, and 14 schematically illustrate an exemplary method of retrofitting a latch system to a tonneau cover.

### DETAILED DESCRIPTION

This disclosure describes tonneau cover latch systems for motor vehicles. An exemplary latch system may be configured to latch and unlatch the tonneau cover relative to a cargo bed of a motor vehicle. The latch system may include a first striker mounted to a first side wall of the cargo bed, and a first latch assembly movable between a first position in which the first latch assembly is engaged to the first striker and a second position in which the first latch assembly is disengaged from the first striker. In an exemplary method, the latch system may be retrofitted to a tonneau cover as a drop-in replacement part of an existing latch system. These and other features of this disclosure are discussed in greater detail in the following paragraphs of this detailed description.

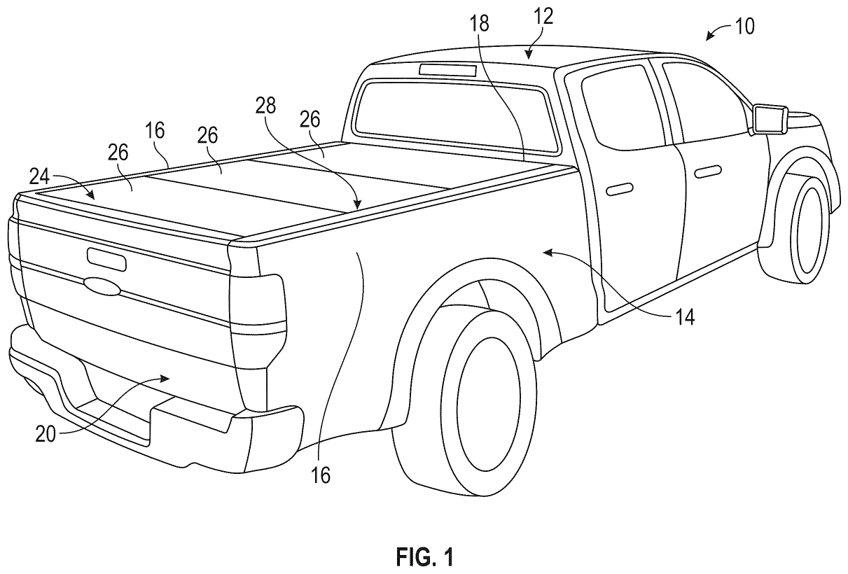

FIGS. 1-3 schematically illustrate a motor vehicle 10 that includes a passenger cabin 12 and a cargo bed 14 located rearward of the passenger cabin 12. The vehicle 10 could be a conventional, internal combustion engine powered vehicle, a hybrid or plug-in hybrid vehicle, a battery electric vehicle, an autonomous vehicle (i.e., a driverless vehicle), etc.

Although a specific component relationship is illustrated in the figures of this disclosure, the illustrations are not intended to limit this disclosure. The placement and orientation of the various components of the depicted vehicles are shown schematically and could vary within the scope of this disclosure. In addition, the various figures accompanying this disclosure are not necessarily drawn to scale, and some features may be exaggerated or minimized to emphasize certain details of a particular component or system.

In an embodiment, the vehicle 10 is a pickup truck, and therefore the cargo bed 14 establishes a rear cargo space for storing and/or hauling cargo on the pickup truck. The cargo bed 14 may generally be defined by side walls 16, a front wall 18 that is adjacent to the passenger cabin 12, a tailgate 20 that acts as a rear wall of the cargo bed 14 when closed, and a floor 22 that acts as a base of the cargo bed 14. The tailgate 20 may be moved between the closed position and an open position to gain access to the cargo bed 14 from the rear of the vehicle 10.

A tonneau cover 24 may be secured in place for closing off a top side of the cargo bed 14 (e.g., the side opposite from the floor 22, which would otherwise be open to the exterior environment). The tonneau cover 24 may span laterally between the side walls 16 and longitudinally between the front wall 18 and the tailgate 20. The tonneau cover 24 and the cargo bed 14 may therefore cooperate to establish an enclosed cargo space of the vehicle 10. The tonneau cover 24 can function to protect cargo being hauled within the cargo bed 14 from environmental elements (e.g., dust, dirt, debris, rain, snow, etc.) and further to enhance the overall aesthetics of the vehicle 10.

The tonneau cover 24 may include a plurality of panels 26 that are individually foldable relative to one another. For example, the panels 26 may be folded over top of one another to expose portions of or substantially all of the cargo bed 14.

The panels 26 may be supported by a frame 28. The frame 28 may include a pair of side rails 30 and a plurality of crossbars 32 that extend laterally between the side rails 30.

In an embodiment, the tonneau cover 24 is a tri-fold tonneau cover. However, other types of tonneau covers could also benefit from the teachings of this disclosure.

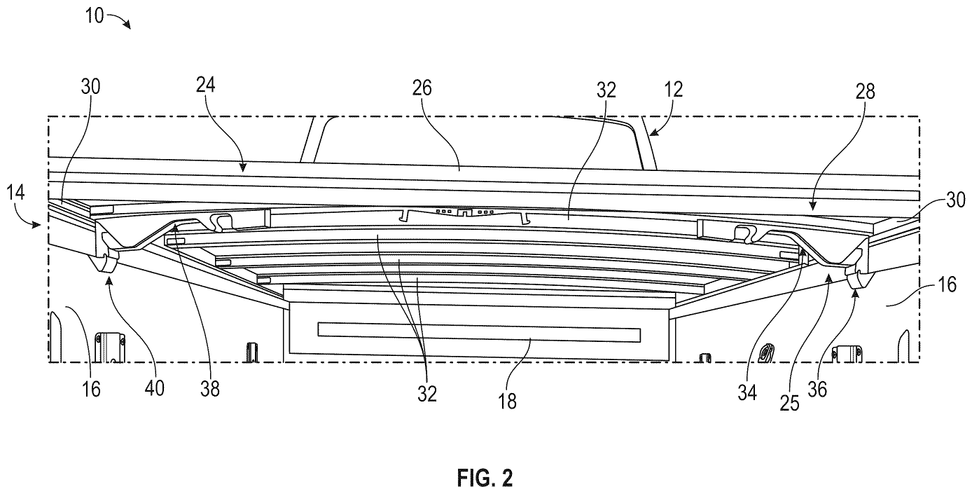

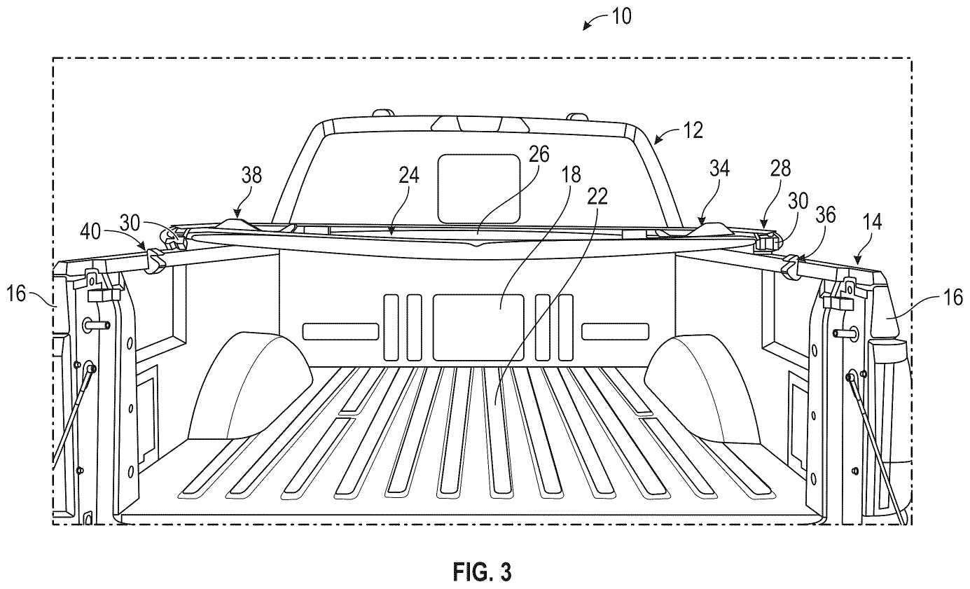

Referring now primarily to FIGS. 2-3, the tonneau cover 24 may be secured to the cargo bed 14 by a latch system 25. The latch system 25 may include a first latch assembly 34, a first striker 36 mounted to the side wall 16 located on a passenger side of the vehicle 10 at a location capable of interfacing with the first latch assembly 34, a second latch assembly 38, and a second striker 40 mounted to the side wall 16 located on a driver side of the vehicle 10 at a location capable of interfacing with the second latch assembly 38.

The first latch assembly 34 and the second latch assembly 38 may each be moved between a first position and a second position to unlatch/unlock/release the tonneau cover 24 from the cargo bed 14 and thereby allow the rearmost or tailgate-end panel 26 to be released for rotation relative to the other panels 26 of the tonneau cover 24. In their respective first positions (see FIG. 2), the first latch assembly 34 is engaged to the first striker 36 and the second latch assembly 38 is engaged to the second striker 40 to securely latch the tonneau cover 24 to the cargo bed 14. The tonneau cover 24 may be moved to the latched position with the tailgate 20 in either the closed position or the open position.

In their respective second positions (see FIG. 3), the first latch assembly 34 is disengaged from the first striker 36 and the second latch assembly 38 is disengaged from the second striker 40. Once the first latch assembly 34 and the second latch assembly 38 are moved to the second positions and are thus disengaged from the first striker 36 and the second striker 40, respectively, the rearmost panel 26 of the tonneau cover 24 may be folded relative to the other panels 26 in order to expose select portions of the cargo bed 14. Additional panels 26 may then be folded as desired.

Although the latch system 25 is illustrated as including two latch assemblies and two strikers in the exemplary embodiment shown in FIGS. 1-3, the latch system 25 could include a greater number of latch assemblies and corresponding strikers within the scope of this disclosure. For example, additional sets of latch assemblies and strikers could be provided for unlatching and rotating the middle panel 26 relative to the frontmost or cab-side panel 26 of the tonneau cover 24.

Unlike known latch systems that typically require a user to unlatch each side of the tonneau cover separately, the latch system 25 provides an ergonomic design in which a user is capable of simultaneously actuating both the first latch assembly 34 and the second latch assembly 38 to unlatch/unlock/release the tonneau cover 24 relative to the cargo bed 14. Moreover, as further described below, the motion required to actuate the first latch assembly 34 and the second latch assembly 38 to disengage from the strikers is inboard (e.g., away from the side walls 16 and toward a centerline of the vehicle 10), thereby reducing the likelihood of the user contacting the side walls 16 with their hands when unlatching the tonneau cover 24.

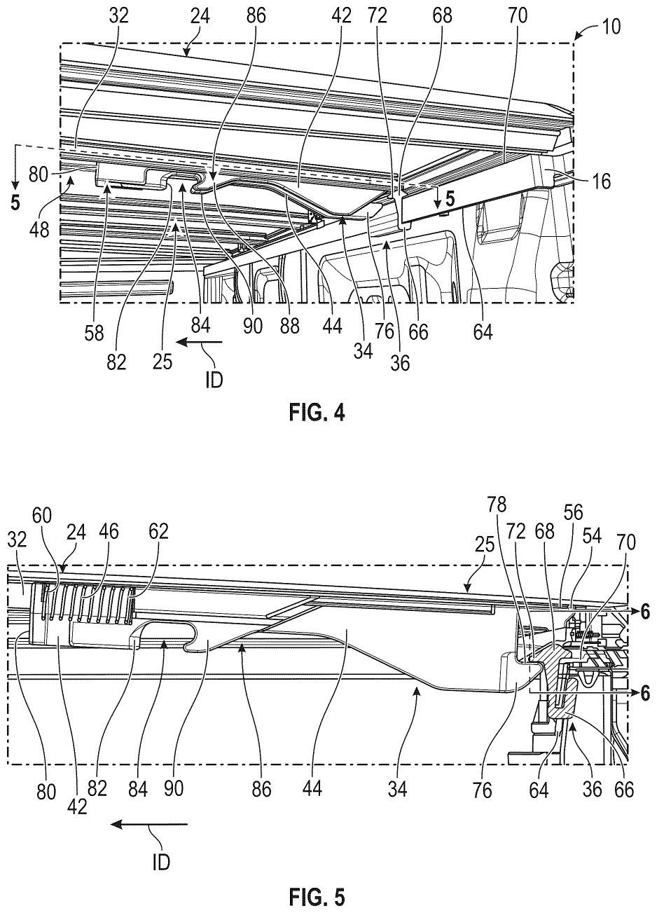

The first latch assembly 34 and the first striker 36 of the latch system 25 are further illustrated with reference to FIGS. 4, 5, 6, and 7. As would be appreciated by a person of ordinary skill in the art, the manner in which the second latch assembly 38 is configured to operate and interface with the second striker 40 is identical to that described herein for the first latch assembly 34 and the first striker 36. Accordingly, in the interests of brevity, the second latch assembly 38 and the second striker 40 are not independently described below and are assumed to incorporate the same features and functionality as the first latch assembly 34 and the first striker 36, respectively.

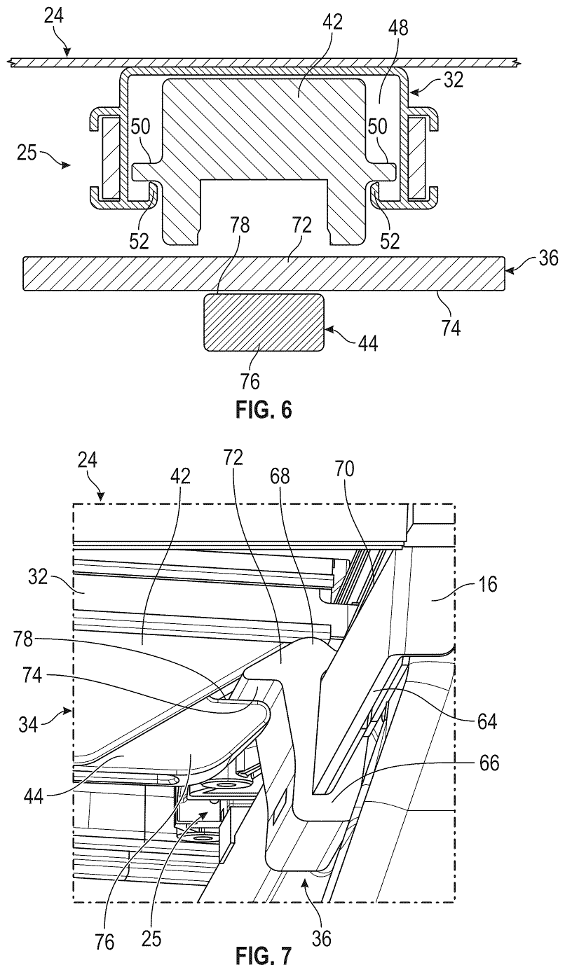

The first latch assembly 34 may include a stationary carrier 42, a movable latch component 44, and a spring 46 (see FIG. 5) arranged between the stationary carrier 42 and the movable latch component 44. The stationary carrier 42 may be secured to one of the crossbars 32 of the tonneau cover 24. In an embodiment, the stationary carrier 42 is inserted into a C-channel 48 of the crossbar 32. A catch 54 (see FIG. 5) located at an outboard end of the stationary carrier 42 may delimit an insertion distance of the stationary carrier 42 into the C-channel 48. For example, the catch 54 may abut against an outboard end surface 56 of the crossbar 32 to prevent over-insertion of the stationary carrier 42. Once inserted, outward projecting ears 50 of the stationary carrier 42 may interface with an upward facing flange 52 of the crossbar 32 to prevent the stationary carrier 42 from falling out of the C-channel 48 (see FIG. 6).

The movable latch component 44 may be movably coupled to the stationary carrier 42. The movable latch component 44 may be accommodated within a longitudinal slot 58 of the stationary carrier 42 and may be translated along a longitudinal axis of the longitudinal slot 58 in order to transition the first latch assembly 34 between the first and second positions. A first length of the longitudinal slot 58 is greater length than a second length of the movable latch component 44 to permit movement therebetween.

The spring 46 may extend between a first spring bearing surface 60 of the stationary carrier 42 and a second spring bearing surface 62 of the movable latch component 44 (see FIG. 5). The first spring bearing surface 60 may be provided at or near an opposite end of the stationary carrier 42 from the catch 54, and the second spring bearing surface 62 may be provided at or near an inboard end portion of the movable latch component 44. The spring 46 may be configured to bias the movable latch component 44 into engagement with the first striker 36. A default position of the first latch assembly 34 is therefore the first position.

The first striker 36 may be mounted to a downfacing flange 64 of one of the side walls 16 of the cargo bed 14. The first striker 36 may include a footprint that is substantially smaller than the length of the side wall 16. The first striker 36 therefore only extends along a discrete portion of the side wall 16.

The first striker 36 may include a mounting portion 66 and a head portion 68 that is integrally formed with the mounting portion 66. In an embodiment, the first striker 36 is snap-connected to the side wall 16 such that the mounting portion 66 substantially surrounds the downfacing flange 64 and the head portion 68 abuts a top surface 70 of the side wall 16. However, other mounting configurations are also contemplated with the scope of this disclosure. For example, the first striker 36 could be mechanically fastened to the side wall 16 using any combination of bolts, clamps, adhesives, etc. In yet another embodiment, the first striker 36 could be integrally formed as part of the side wall 16.

The head portion 68 of the first striker 36 may include an inboard extending flange 72 that extends in a direction inboard of the side wall 16. An undersurface 74 of the inboard extending flange 72 may provide a first latching interface of the latch system 25.

The movable latch component 44 may include a latching flange 76 provided at its outboard end. A top surface 78 of the latching flange 76 may provide a second latching interface of the latch system 25. The top surface 78 of the latching flange 76 may engage the undersurface 74 of the inboard extending flange 72 to latch the tonneau cover 24 to the cargo bed 14 when the first latch assembly 34 is in the default or first position. As alluded to above, the spring 46 may be configured to bias the movable latch component 44 toward the first striker 36 to allow the top surface 78 of the latching flange 76 to engage the undersurface 74 of the inboard extending flange 72 and thereby latch the tonneau cover 24 relative to the cargo bed 14. The latch system 25 may produce an audible latching sound that is satisfying to the user as the latching flange 76 engages the first striker 36 in the manner described above.

The stationary carrier 42 may provide a first grip surface 80 of the first latch assembly 34, and the movable latch component 44 may provide a second grip surface 82 of the first latch assembly 34. The first grip surface 80 may be provided at an inboard end of the stationary carrier 42, and the second grip surface 82 may be provided near an inboard end of the movable latch component 44 that is located on an opposite side from the latching flange 76. The movable latch component 44 may include a finger clearance opening 84 that allows the user to more easily access the second grip surface 82.

Using a single hand, a user may grasp each of the first and second grip surfaces 80, 82 with one or more fingers of their hand and then squeeze the fingers to move the second grip surface 82 toward the first grip surface 80 and thereby transition the first latch assembly 34 from the first position to the second position. Squeezing at the first and second grip surfaces 80, 82 in this manner can overcome the biasing force of the spring 46 and move the movable latch component 44 in an inboard direction ID relative to the stationary carrier 42 and thereby cause the latching flange 76 to disengage from the inboard extending flange 72 of the first striker 36. Once the movable latch component 44 is released from the first striker 36 in this manner, the user is free to rotate one or more of the panels 26 of the tonneau cover 24 for exposing the cargo bed 14.

The stationary carrier 42 and the movable latch component 44 may also cooperate to establish an anti-theft structure 86 of the first latch assembly 34. The anti-theft structure 86 may be located slightly outboard from the second grip surface 82 of the movable latch component 44. The finger clearance opening 84 may extend between the second grip surface 82 and the anti-theft structure 86.

The anti-theft structure 86 may be configured to block access to the second grip surface 82 by unauthorized users. For example, to the extent a thief attempts to apply an outboard-to-inboard force to the second grip surface 82 using a tool inserted between the tonneau cover 24 and the side wall 16 in order to disengage first latch assembly 34 from the first striker 36, the anti-theft structure 86 may function as a barrier that prevents the tool from accessing the second grip surface 82, thereby acting to prevent the tool from applying the force necessary to move the first latch assembly 34 from the first position to the second position.

The anti-theft structure 86 may include a first blocking structure 88 provided by the stationary carrier 42 and a second blocking structure 90 provided by the movable latch component 44. In an embodiment, each of the first blocking structure 88 and the second blocking structure 90 includes an inverted shark fin-like shape. However, other configurations are contemplated within the scope of this disclosure.

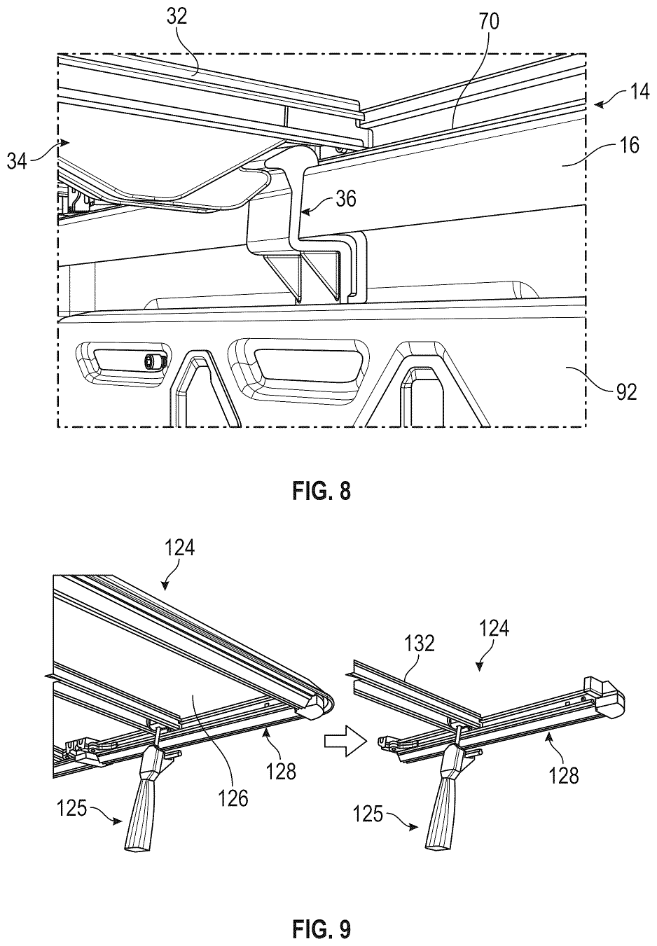

In another exemplary implementation, shown in FIG. 8, an accessory panel 92 may be mounted to the side wall 16 of the cargo bed 14. The accessory panel 92 may allow a user to mount numerous accessories to the cargo bed 14. Notably, the first latch assembly 34 and the first striker 36 are mounted in an manner that does not interfere with use of the accessory panel 92 by utilizing a clearance space between the accessory panel 92 and the top surface 70 of the side wall 16.

FIGS. 9-14 schematically illustrate an exemplary method that can be utilized by a user for retrofitting an existing tonneau cover 124 with the latch system 25 described above. The latch system 25 may be provided as a drop-in replacement of an existing latch system 125 of the tonneau cover 124 without requiring the use of any specialized tooling.

Referring first to FIG. 9, the tonneau cover 124 may be disassembled until reaching a crossbar 132 onto which the existing latch system 125 is mounted. Disassembly of the tonneau cover 124 may include detaching one or more panels 126 from a frame 128 of the tonneau cover 124, for example.

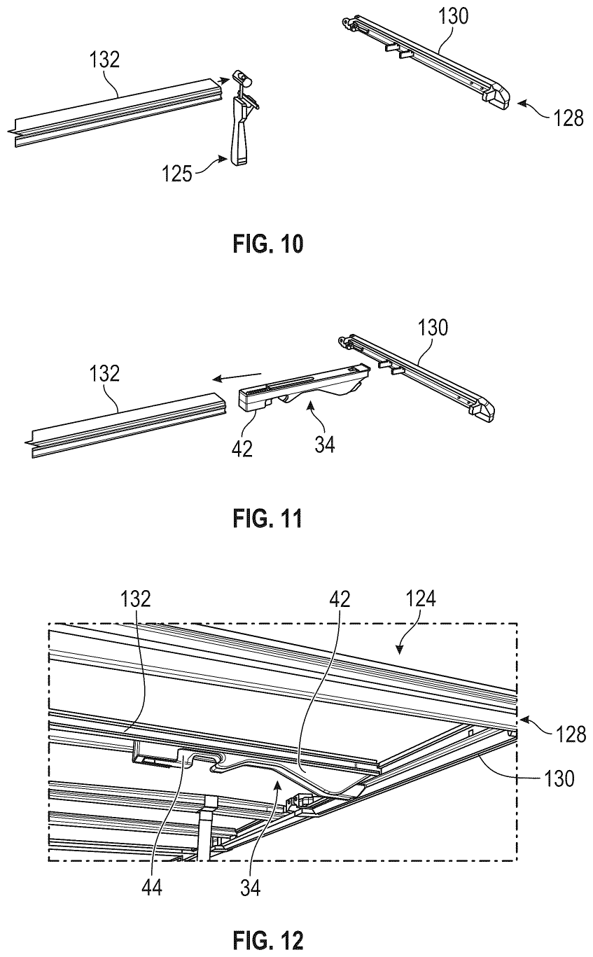

Referring next to FIG. 10, the crossbar 132 may be disconnected from a side rail 130 of the frame 128. The existing latch system 125 may then be removed from the crossbar 132.

Next, as shown in FIG. 11, the first latch assembly 34 of the latch system 25 may be assembled to the crossbar 132. This step may include inserting the stationary carrier 42 into a longitudinal channel of the crossbar 132. The crossbar 132 may then be reconnected to the side rail 130. The portion of the tonneau cover 124 that was previously disassembled may than be reassembled to the frame 128 (see FIG. 12).

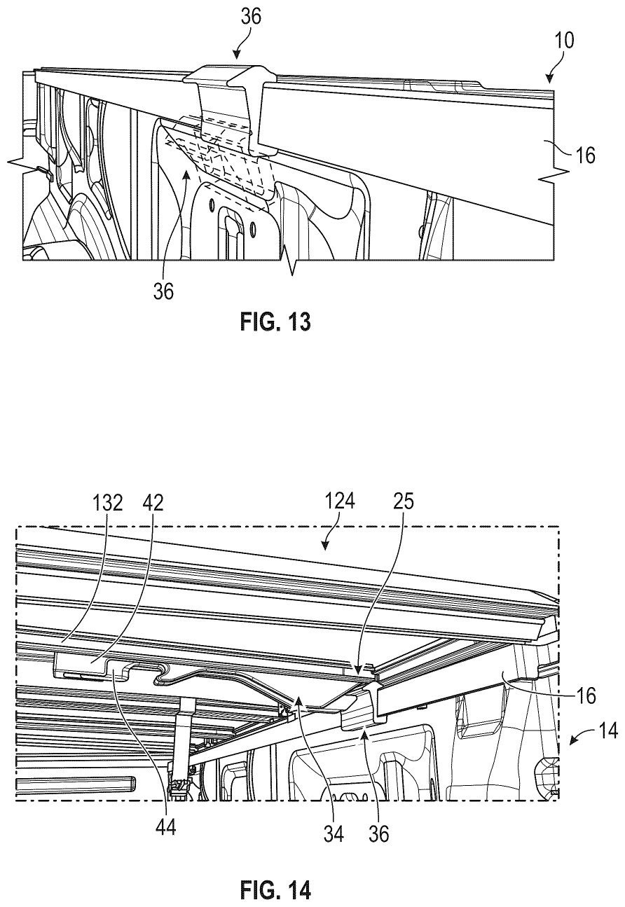

Referring next to FIG. 13, the first striker 36 of the latch system 25 may be installed onto the side wall 16 of the vehicle 10. The steps shown in FIGS. 10-13 may then be repeated in order to install the second latch assembly 38 and the second striker 40 onto the crossbar 132 and the opposite side wall 16, respectively.

Finally, as shown in FIG. 14, after visually inspecting alignment of the first latch assembly 34 to the first striker 36 and the second latch assembly 38 to the second striker 40 (not shown), the tonneau cover 124 may be lowered down and latched to the cargo bed 14 via the latch system 25.

Although the above method is described as a retrofitting method, the latch system 25 of this disclosure could alternatively be provided as an original component of a tonneau cover.

The exemplary tonneau cover latch systems of this disclosure provide a more ergonomic and user friendly latching experience compared to existing latching designs. The proposed systems provide users the ability to unlatch both sides of the tonneau cover simultaneously, without special tools, and without interfering with usage of cargo bed accessory panels. The proposed systems may further provide an outboard-to-inboard unlatching motion path that reduces the likelihood of the user contacting the cargo bed side walls with his/her hands when attempting to unlatch the tonneau cover.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A motor vehicle, comprising:
a cargo bed;
a tonneau cover; and
a latch system configured to latch and unlatch the tonneau cover relative to the cargo bed,
wherein the latch system includes a first striker mounted to a first side wall of the cargo bed and a first latch assembly movable between a first position in which the first latch assembly is engaged to the first striker and a second position in which the first latch assembly is disengaged from the first striker.

2. The motor vehicle as recited in claim 1, wherein the first striker extends along only a discrete portion of a length of the first side wall.

3. The motor vehicle as recited in claim 1, wherein the first striker includes a mounting portion that interfaces with a downfacing flange of the first side wall and a head portion that interfaces with a top surface of the first side wall.

4. The motor vehicle as recited in claim 3, wherein the head portion includes an inboard extending flange that provides a first latching interface of the latch system.

5. The motor vehicle as recited in claim 4, wherein a movable latch component of the first latch assembly includes a latching flange that provides a second latching interface of the latch system.

6. The motor vehicle as recited in claim 5, wherein a top surface of the latching flange engages an undersurface of the inboard extending flange to latch the tonneau cover to the cargo bed when the first latch assembly is in the first position.

7. The motor vehicle as recited in claim 1, wherein the first latch assembly includes a stationary carrier, a movable latch component, and a spring configured to bias the movable latch component into engagement with the first striker.

8. The motor vehicle as recited in claim 7, wherein the stationary carrier provides a first grip surface of the first latch assembly, and the movable latch component provides a second grip surface of the first latch assembly, and further wherein the second grip surface is movable toward the first grip surface to disengage the movable latch component from the first striker.

9. The motor vehicle as recited in claim 8, wherein the second grip surface is accessible via a finger clearance opening of the first latch assembly.

10. The motor vehicle as recited in claim 7, wherein the first latch assembly includes an anti-theft structure established by a first blocking structure of the stationary carrier and a second blocking structure of the movable latch component.

11. The motor vehicle as recited in claim 1, wherein the latch system includes a second striker mounted to a second side wall of the cargo bed and a second latch assembly movable between a first position in which the second latch assembly is engaged to the second striker and a second position in which the second latch assembly is disengaged from the second striker.

12. The motor vehicle as recited in claim 11, wherein the first latch assembly and the second latch assembly are simultaneously movable between the first positions and the second positions by a single user.

13. A latch system for a tonneau cover, comprising:
a first striker; and
a first latch assembly including a stationary carrier, a movable latch component, and a spring configured to bias the movable latch component into engagement with the first striker.

14. The latch system as recited in claim 13, wherein the stationary carrier provides a first grip surface of the first latch assembly, and the movable latch component provides a second grip surface of the first latch assembly, and further wherein the second grip surface is movable toward the first grip surface to disengage the movable latch component from the first striker.

15. The latch system as recited in claim 14, wherein the second grip surface is accessible via a finger clearance opening of the first latch assembly.

16. The latch system as recited in claim 13, wherein the stationary carrier is mountably received within a C-channel of a crossbar of the tonneau cover.

17. The latch system as recited in claim 16, wherein the stationary carrier includes a catch that is configured to abut against an outboard end surface of the crossbar to delimit an insertion distance of the stationary carrier into the C-channel.

18. The latch system as recited in claim 13, wherein the first latch assembly includes an anti-theft structure established by a first blocking structure of the stationary carrier and a second blocking structure of the movable latch component.

19. The latch system as recited in claim 18, wherein the first blocking structure and the second blocking structure each include an inverted shark fin-like shape.

20. A method for retrofitting a latch system onto a tonneau cover, comprising:
disassembling a portion of the tonneau cover to expose a crossbar;
removing an existing latch assembly from the crossbar;
securing a latch assembly of the latch system to the crossbar; and
reassembling the portion of the tonneau cover.
